(19) United States
(12) Patent Application Publication
(10) Pub. No.: US 2007/0187385 A1
(43) Pub. Date: Aug. 16, 2007

(54) Power tool assembly

(75) Inventors: Grigore Axinte, Kent, WA (US); Dragos Axinte, Bellevue, WA (US); John Lu, Renton, WA (US); Russell Borgmann, Bellevue, WA (US); Jeff Campbell, Bellevue, WA (US)

Correspondence Address: Michael A. Oblon;Patent Procurement, Perkins Coie LLP, 607 Fourteenth Street N.W., Washington, DC, 20005-2011, US

(73) Assignee: Hyperion Innovations, Inc., Bellevue, WA (US)

(21) Appl. No.: 11/248,276

(22) Filed: Oct. 13, 2005

Related U.S. Application Data
(63) Continuation-in-part of application No. 10/656,900, filed on Sep. 5, 2003, now abandoned.
Application No. 10/656,900 is a continuation of application No. 10/016,937, filed on Dec. 14, 2001, now Pat. No. 6,646,228.
Application No. 10/016,937 is a continuation-in-part of application No. 09/726,546, filed on Aug. 18, 2000, now Pat. No. 6,797,924.
(60) Provisional application No. 60/149,416, filed on Aug. 18, 1999.
(60) Provisional application No. 60/618,945, filed on Oct. 13, 2004.
(60) Provisional application No. 60/626,505, filed on Nov. 8, 2004.

(51) Int. Cl. H05B 3/42

(52) U.S. Cl. 219/229; 219/231

(57) ABSTRACT

A power tool assembly, such as a soldering tool, is provided with a power tool having a functional end, a cap for protecting the functional end of the power tool, a first receiving surface on the power tool at least proximate to the functional end for removably attaching the cap to the power tool to cover the functional end. The power tool also has a second receiving surface on the power tool for removably attaching the cap to the power tool at a surface other than the first receiving surface when the functional end of the power tool is in use.

### CROSS-REFERENCES TO RELATED APPLICATIONS

This application is a continuation-in-part of pending U.S. patent application Ser. No. 10/656,900, filed Sep. 5, 2003, which is a continuation of U.S. patent application Ser. No. 10/016,937, filed Dec. 14, 2001 and issued as U.S. Pat. No. 6,646,228, which is a continuation-in-part of U.S. patent application Ser. No. 09/726,546, filed Aug. 18, 2000, and claims the benefit of U.S. Provisional Patent No. 60/149,416, filed Aug. 18, 1999. This application also claims the benefit of U.S. Provisional Patent Nos. 60/618,945, filed Oct. 13, 2004, and 60/626,505, filed Nov. 8, 2004. The disclosures of all related applications cited above are hereby incorporated by reference herein in their entirety.

### FIELD OF THE INVENTION

The present invention generally relates to power tools, and more particularly, to a protective cap for a power tool.

### BACKGROUND OF THE INVENTION

Soldering irons are often used when it is required to make manual electrical conductive connections between various electrical components. Soldering irons are used for a variety of applications, such as the repair of printed circuit boards in many different industries, such as in telecommunications or computer manufacturing or repair. Known soldering irons vary by power source, application, performance, shape, size, temperature, tip type, heat source, price, and portability.

Various soldering irons exist today, including both corded and cordless soldering irons. Corded soldering irons use a power cord to deliver AC power to the soldering iron from a common household outlet. For a corded soldering iron, a stepdown transformer converts the power supplied to the soldering iron from AC to DC for heating the electrode(s) at the soldering iron tip. One type of cordless soldering iron is a butane soldering iron, which uses a highly flammable gas to heat a tip of the soldering iron.

There are many types of cordless power tools, such as drills, screwdrivers, nail guns, and saws. Cordless power tools are generally portable for enabling tool operation at job sites where AC power may not be easily accessible. A disadvantage that is associated with this flexibility, however, is that portable tools are often susceptible to damage when exposed to inclement weather, debris, and dust. Portable power tools are also susceptible to damage when the tool is placed into or removed from a toolbox before or after use.

Protective caps have been used for many years on pens and other devices. The purpose of using a cap on a pen generally is to prevent ink within the pen from drying out, to protect a user's pockets and hands from ink stains, and to prevent ink from leaking from the pen. Protective covers also have been used on hand tools, such as wrenches and sockets, to protect the surfaces of the objects to which the tools are being applied. The protective covers are placed on working surfaces of the wrench or socket and remain on the surfaces during use of the tool. The cover typically is made of plastic and is replaceable once the cover wears with use. As another example, protective caps have been used on explosive powder actuated or gas actuated setting tools. These setting tools drive a nail or other fastening device into the material being fastened by using high-pressure gas typically generated from an explosive powder cartridge. These setting tools consist of a setting end that delivers the force from the high pressure gas to the nail and a housing that contains the apparatus for producing or delivering the high pressure gas. In this particular example, the protective cap is placed on the setting end of the tool housing and protects the housing at the setting end from wear and impact damage due to conditions at a job site. The protective cap remains affixed on the setting end during both use and storage. The protective cap is removable so that it can be replaced over time as it wears from use. As yet another example, knife and blade type tools often have protective covers to prevent injury to the user. These blade covers can be in the form of a separate sheath that the knife resides in when not in use, or alternatively, the cover can be attached to the blade body itself. Covers that are attached to the blade itself protect the user by allowing the user to cover the blade surface quickly when not in use. When the blade is in use the cover pivots about a point of attachment on the body of the blade exposing the working surface of the blade, but at all times the cover remains attached to the blade.

### SUMMARY OF THE INVENTION

Generally described, the present invention is directed to a power tool with a cap for protecting the functional end of the power tool and a first receiving surface located on the power tool at least proximate to the functional end for removably attaching the cap to the power tool to cover the functional end. The power tool also has a second receiving surface located on the power tool for removably attaching the cap to the power tool at a surface other than the first receiving surface when the power tool is in use.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is an elevation view of a soldering tool in accordance with an embodiment of the present invention;

FIG. 2 is a front elevation view of a soldering tip in the soldering tool of FIG. 1;

FIG. 3 is a circuit for a soldering tool in accordance with an embodiment of the present invention;

FIG. 4 is an elevation view of the soldering tool of FIG. 1;

FIG. 5A is a top perspective view of another soldering tool with an integrated cap assembly, in accordance with an embodiment of the present invention;

FIG. 5B is a top perspective view of the soldering tool of FIG. 5A;

FIG. 5C is a bottom perspective view of the soldering tool of FIG. 5A;

FIG. 5D is a bottom perspective view of the soldering tool of FIG. 5A;

FIG. 6 is an elevation view of another soldering tool with an integrated cap assembly, in accordance with an embodiment of the present invention;

FIG. 7 is an elevation view of a tip assembly for use with the soldering tool of FIG. 6;

FIG. 8 is an elevation view of a tip assembly for use with the soldering tool of FIG. 6; and

FIG. 9 is a cross section view of the tip assembly taken along cross sectional lines 10-10 in FIG. 8.

### DETAILED DESCRIPTION OF PREFERRED EMBODIMENTS

The present invention will now be described with reference to the disclosed drawings. Embodiments of the present invention are directed to power tools generally. The following descriptions and illustrations herein should be considered illustrative in nature, and thus, not limiting the scope of the present invention as claimed.

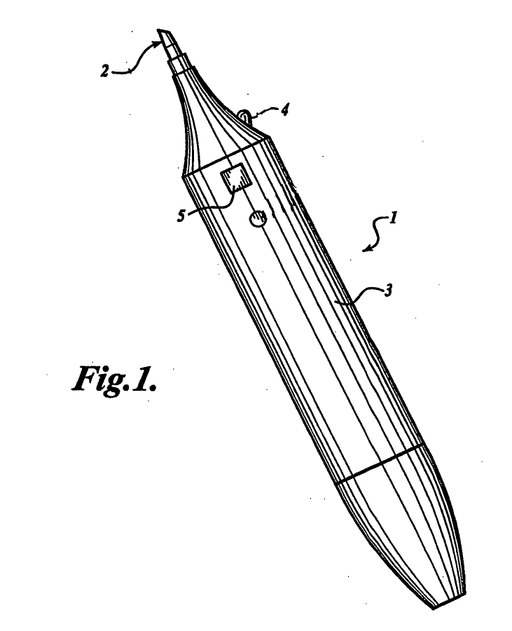

Referring to FIG. 1, one exemplary embodiment of a cordless soldering tool 1 formed in accordance with an embodiment the present invention is illustrated. The soldering tool 1 includes a tip 2 attached to a body 3. The soldering tool tip 2 completes an electrical circuit upon contact with solder material or a workpiece. The soldering tool 1 further includes an electric light 4 disposed on the body 3 in order to illuminate the tip 2 and any surrounding work surfaces that may be in the vicinity of the soldering tool 1. A switch 5 that is disposed on the body 3 controls the operation of the electric light 4. As can be seen, the body 3 includes an elongated, substantially tubular member constructed of a rigid heat-resistant material, such as plastic or other materials known to those of ordinary skill in the art. The body 3 is generally a unitary structure, assembled in parts, and configured to hold the sub-components and circuitry described herein. The soldering tool 1 is powered by batteries (not shown) and thus operates without a cord. Because the soldering tool 1 has no cord, it is very portable. The portability of this soldering tool 1 allows for use in many different environments, such as a job site where AC power is not conveniently accessible or on a ladder or in other areas with difficult accessibility to AC power.

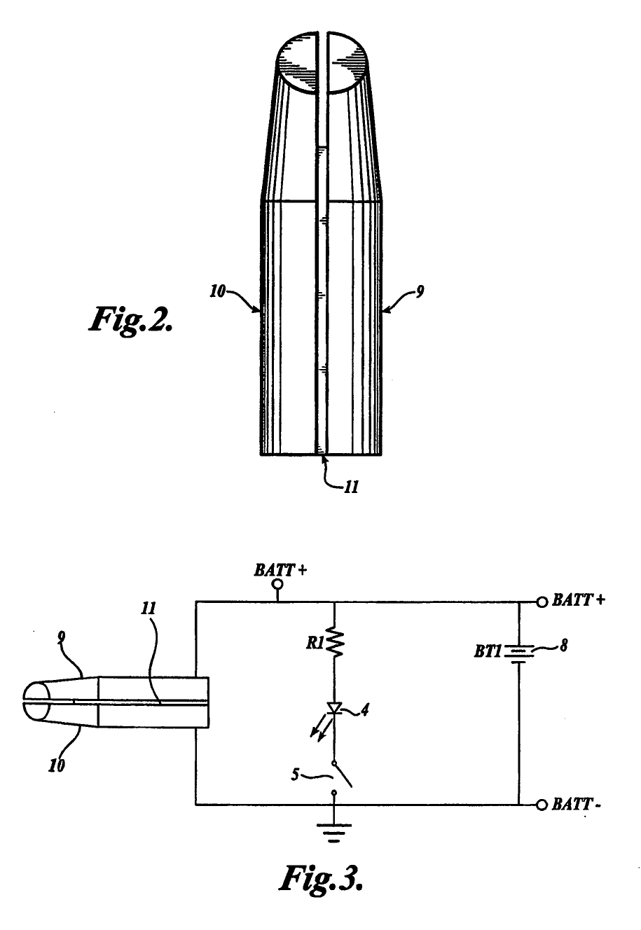

FIG. 2 is a front elevation view of a soldering tip 2 used in accordance with the embodiment of FIG. 1. As illustrated, the tip 2 includes two electrodes 9 and 10 that are electrically isolated from one another by an insulator 11 disposed therebetween. The size and shape of the tip 2 may vary depending upon the soldering application required by a particular application and/or industry. The tip 2 is generally attached to the body 3 of the soldering iron 1, preferably in a detachable manner. Making the tip 2 detachable in several embodiments facilitates replacement of the tip 2 if it becomes damaged or otherwise unusable. Moreover, because of the detachable nature of the tip 2, the user of the soldering iron 1 may use different tips interchangeably for different soldering applications.

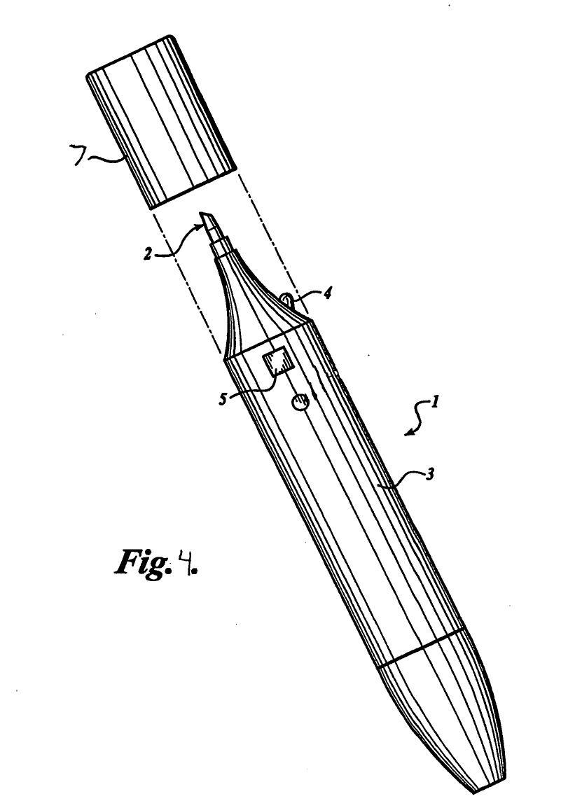

FIG. 3 illustrates a circuit schematic for the solder tool illustrated in FIG. 1. When the tip 2 is secured to the soldering iron 1, the electrodes 9 and 10 are separately electrically connected to the positive and negative terminals of an electrical power source 8. In one embodiment, metallic contacts (not shown) are utilized to supply power to the electrodes 9 and 10. The contacts are coupled to the body 3 and electrically connect to the remaining components of the circuit shown in FIG. 3. When assembled, the electrodes 9 and 10 contact the spaced contacts in a manner that provides electrical intercommunication. The contacts are preferably bent to function as a spring to minimize contact resistance. In the case of the circuit illustrated in FIG. 3, the electrical power source 8 is a battery (BT1). However, a variety of electrical power sources 8 can be used, including rechargeable or non-rechargeable batteries or battery cells, or a low-voltage power source provided via a power providing device.

When the ends of the electrodes 9 and 10 are applied to an electrically conductive or semi-conductive material, such as solder or a workpiece, an electrical circuit is completed from the positive terminal of the electrical power source 8, through the electrode 9, further through the electrically conductive or semi-conductive material to which the tip 2 has been applied, and even further through the electrode 10 and completed back to the negative terminal of the electrical power source 8. In completing the circuit by way of the electrodes 9 and 10 and the electrically conductive or semi-conducted material used in conjunction with electrodes 9 and 10, a flow of electricity from the electrical power source 8 causes the tip 2 to heat to a high temperature within a few seconds. As a result of the materials used in conjunction with the electrodes 9 and 10, the tip 2 does not become soldered to the joint while being used to create a solder connection. Once the electrodes 9 and 10 are removed from or are taken away from contact with the electrically conductive or semi-conductive material, the circuit to the electrical power source 8 is disconnected and therefore, the soldering iron is put into a non-heating state. In this state, the electrodes 9 and 10 cool to a safe temperature.

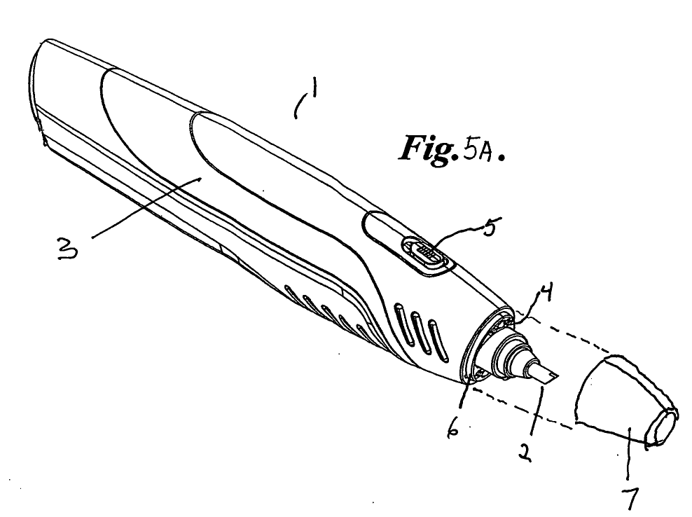

FIG. 4 is an elevation view of the soldering tool of FIG. 1 in accordance with an embodiment of the present invention. The soldering tool 1 also has a cap 7 that is adapted to protect the tip 2 while the soldering tool 1 is not in use; for example, when the soldering tool 1 is in transit or storage. The cap 7 protects the tip 2 and the light 4 from impact, or from other forces that could damage the tip 2 and/or the light 4. The cap 7 is of a shape that protects the split tip 2 and the light 4 and is constructed of a rigid heat-resistant material, such as plastic or other material known to those of ordinary skill in the art. The cap 7 in this embodiment of the present invention is of a solid character. It should be noted, however, that further embodiments of the present invention include a cap with perforations, or of a cage construction, that would allow air to freely circulate through the cap, while still providing protection to the split tip 2 and light 4. In this present embodiment the cap 7 is removably affixed to the tool by a friction fit. In further embodiments of the present invention, the cap 7 is removably affixed to the body 3 by a clamp, threaded surfaces, or by other fixation methods known to those of ordinary skill in the art.

Similar to the soldering tool illustrated in FIGS. 1-4, FIG. 5A is a top perspective view of another soldering tool in accordance with an embodiment of the present invention. The soldering tool includes a tip 2 attached to a body 3. The soldering tool 1 tip 2 completes an electrical circuit upon contact with solder material or a workpiece. The soldering tool 1 further includes an electric light 4 disposed on the body 3 in order to illuminate the tip 2 and any surrounding work surfaces that may be in the vicinity of the soldering tool 1. A switch 5 that is disposed on the body 3 controls the operation of the electric light 4. As can be seen, the body 3 includes an elongated, substantially tubular member constructed of a rigid heat-resistant material, such as plastic or other materials known to those of ordinary skill in the art. The body 3 is generally a unitary structure, assembled in parts, and figured to hold the sub-components and circuitry described herein. The soldering tool 1 is powered by batteries (not shown) and thus operates without a cord. Because the soldering tool 1 has no cord, it is very portable. The portability of this soldering tool 1 allows for use in many different environments, such as a job site where AC power is not conveniently accessible or on a ladder or in other areas with difficult accessibility to AC power.

Also located on the body 3 proximate to the split tip 2 is an indented ledge 6 formed in the plastic for receiving a cap 7 while the tool is not in use, such as when the cordless soldering tool 1 is in transit or storage. The cap 7 protects the split tip 2 and the light 4 from impact or from other forces that could damage the split tip 2 and/or the light 4. The cap 7 is of a shape that protects the split tip 2 and the light 4 and is constructed of a rigid heat-resistant material, such as plastic or other material known to those of ordinary skill in the art. The cap 7 in this embodiment of the present invention is of a solid character. It should be noted, however, that further embodiments of the present invention include a cap with perforations or of a cage construction that would allow air to freely circulate through the cap while still providing protection to the split tip 2 and light 4. In this present embodiment, the cap 7 is removably affixed at the indented ledge 6 by a friction fit. In further embodiments of the present invention, the cap 7 is removably affixed to the body 3 by a clamp, threaded surfaces, or by other fixation methods known to those of ordinary skill in the art.

In this embodiment of the present invention, the split tip 2 is covered when not in use. The split tip 2 can be damaged by impact and can be lost if dislodged from the body 3. Further, because the soldering tool 1 can be operated in a stand-by mode that activates the device only when it contacts electrically conductive material, the cap 7 prevents activation from inadvertent contact with electrically conductive material.

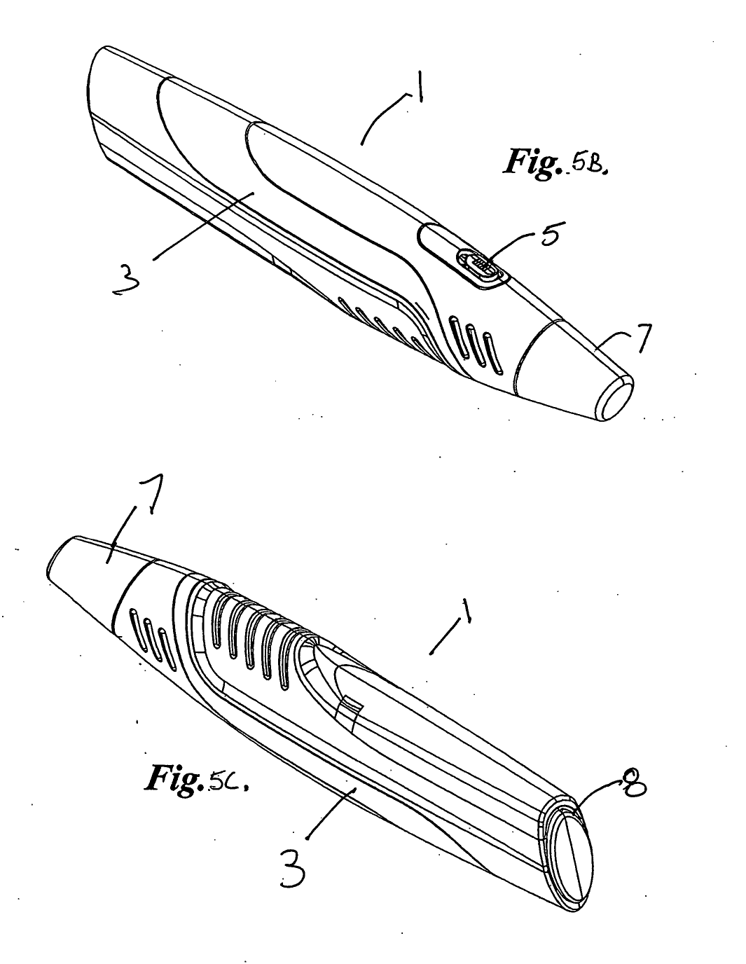

FIG. 5B is a top perspective view of soldering tool of FIG. 5A. The soldering tool 1 includes a body 3 and a cap 7 that covers the split tip (not shown) and light (not shown). FIG. 5C is a bottom perspective view of the soldering tool of FIG. 5A. The soldering tool 1 includes a body 3 and a cap 7 covering the split tip (not shown) and the light (not shown). As can be seen from this perspective, the soldering tool 1 also includes an indented ledge 8 formed in the plastic at the posterior end of the tool for storing the cap 7 when the soldering tool is in use. In the present embodiment, the cap 7 is removably affixed to the body 3 at the indented ledge 8 by a friction fit while the tool is in use. In further embodiments of the present invention, the cap 7 is removably affixed to the body 3 by a clamp, threaded surfaces, or by other fixation methods known to those of ordinary skill in the art.

FIG. 5D is a bottom perspective view of the soldering tool of FIG. 5A. The cap 7 is attached to the body 3 while the soldering tool 1 is in use, thus, a user is less likely to misplace the cap 7 and more likely to cover the split tip 2 when the soldering tool 1 is not in use.

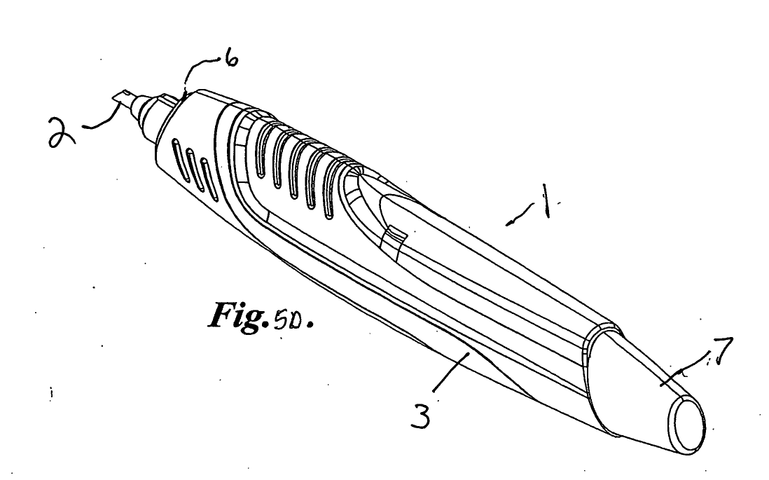

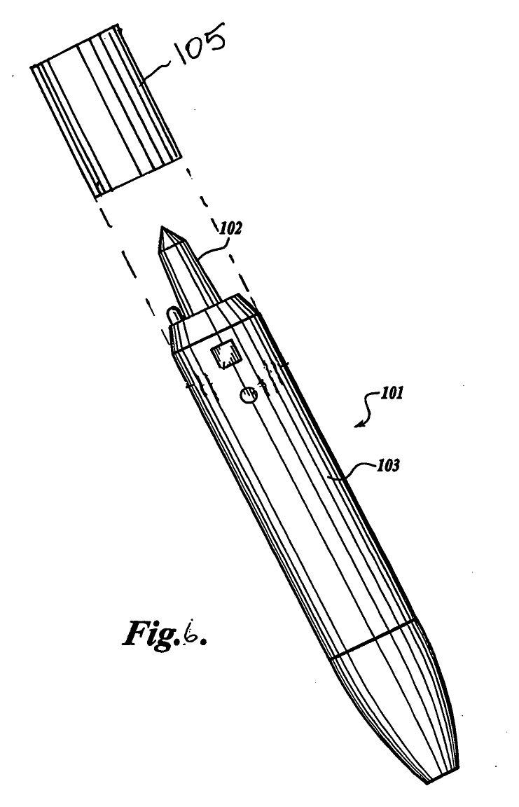

While the preceding embodiments have been illustrated herein and described above as being of a split tip design, i.e., having a tip comprised of first and second electrically isolated electrodes, soldering irons of the present invention may be of the single electrode type. To that end, attention is directed to FIGS. 6 and 7, which illustrate another embodiment of an electrical device, namely, a soldering iron 101 formed in accordance with the present invention. The soldering iron 101 is substantially similar in construction, materials, and operation as the soldering irons illustrated in FIGS. 1-5D, except for the differences that will now be described. As best shown in FIG. 6, the soldering iron 101 comprises a soldering iron tip 102 connected to a soldering iron body 103. As further illustrated by FIG. 6, the soldering iron 101 may also include a cap 105 for covering the tip 102.

As best shown in FIG. 7, the soldering iron 101 further includes a heating device 132 for heating the soldering iron tip 102 to an appropriate temperature to effect soldering of, for example, a workpiece. In one embodiment, the heating device 132 defines a bore 134 into which the proximal end of the soldering iron tip 102 is inserted. The interface between the heating device 132 and the soldering iron tip 102 is preferably of an interference fit for good heat transfer there between. In this embodiment, metallic clamps 138 may be used to route electricity through the heating device 132, or the heating device may be constructed with electrical terminals for electrical connection to the power source. A heat insulating body (not shown) that encases the heating device 132 may further be provided, if desired. The heat insulating body may be constructed of any suitable material, such as heat resistant plastics or ceramics.

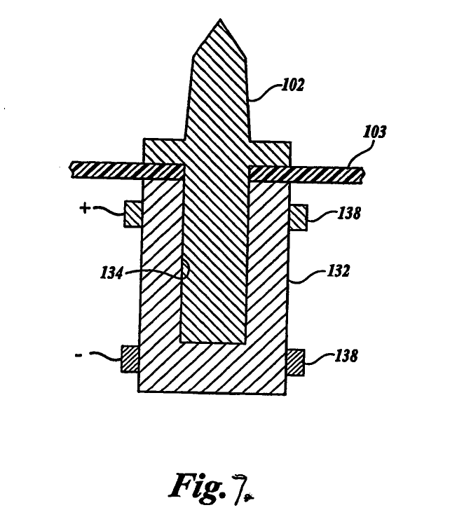

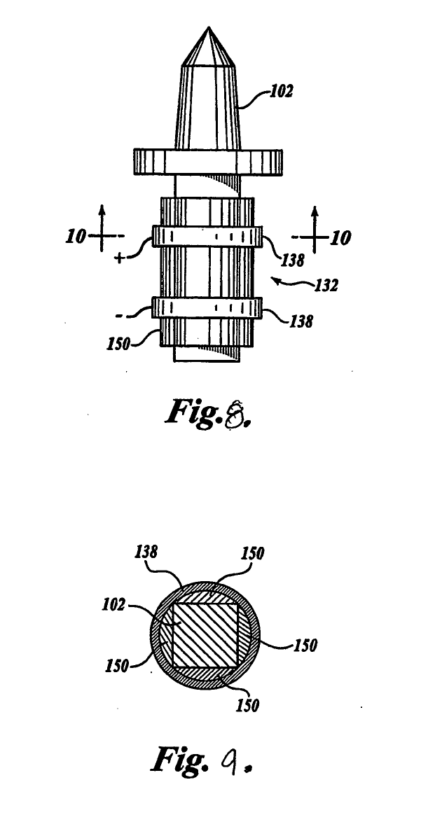

In an alternative embodiment shown in FIGS. 8 and 9, the heating device 132 includes one or more heating elements 150 disposed in heat transfer relationship with the soldering iron tip 102. The heating elements are preferably secured to or maintained adjacent the tip 102 by either mechanical techniques, i.e., brackets, clamps, screws, etc. or chemical techniques, i.e., epoxy, adhesives, to maintain a positive connection there between. In the embodiment shown, the heating elements 150 are held in place via clamps 138 constructed of a metallic material, such as copper. However, other arrangements may be used. For example, the soldering iron body 103 may be specifically designed with flanges, tabs, or other interior structure that retains the heating elements 150 in contact with the soldering iron tip 102 once assembled. The clamps 138 may also be used as power source connection terminals for connecting the heating elements 150 in electrical communication with a power source 108.

While preferred embodiments of the invention have been illustrated and described, it will be appreciated by one skilled in the art that various changes can be made therein without departing from the spirit and scope of the invention as encompassed by the accompanying clauses. Therefore, it is intended in the appended claims to cover all such equivalent variations which may come within the scope of the invention as described.

1. A power tool assembly comprising:
a power tool with a functional end;
a cap for protecting the functional end of the power tool;
a first receiving surface on the power tool at least proximate to the functional end for removably attaching the cap to the power tool to cover the functional end; and
a second receiving surface on the power tool for removably attaching the cap to the power tool at a surface other than the first receiving surface when the functional end of the tool is in use.

2. The power tool assembly of claim 1, wherein the cap is constructed as a cage.

3. The power tool assembly of claim 1, wherein the power tool is a soldering tool.

4. The power tool assembly of claim 1, wherein the cap is made from a hardened material sufficient to protect against impact damage.

5. The power tool assembly of claim 4, wherein the cap is made from a plastic.

6. The power tool assembly of claim 1, wherein the cap is removably affixed to the first receiving surface on the tool by a friction fit, a clamp, or threaded surfaces when the power tool is not in use.

7. The power tool assembly of claim 1, wherein the cap is removably affixed to the second receiving surface on the tool by a friction fit, a clamp, or threaded surfaces when the power tool is in use.

8. The power tool assembly of claim 1, wherein the second receiving surface is located at the posterior end of the power tool.

9. A power tool assembly comprising:
a power tool with a functional end;
a cap for protecting the functional end of the power tool;
means for covering the functional end of the power tool with the cap for protecting the functional end of the power tool; and
means for storing the cap when the power tool is in use.

10. A soldering tool assembly comprising:
a soldering tool having a tip on the soldering tool for heating solder to perform soldering connections;
a cap for protecting the tip of the soldering tool;
a first receiving surface on the soldering tool at least proximate to the tip of the soldering tool for removably attaching the cap to the power tool to cover the tip; and
a second receiving surface on the soldering tool for removably attaching the cap to the power tool at a surface other than the first receiving surface when the tip of the soldering tool is in use.

11. A soldering tool assembly according to claim 10, wherein the cap is constructed as a cage.

12. A soldering tool assembly according to claim 10, wherein the soldering tool has interchangeable tips.

13. A soldering tool assembly according to claim 12, wherein the tip is removably affixed to the soldering tool by a friction fit.

14. A soldering tool assembly according to claim 10, wherein the tip of the soldering tool is split so as to power on the soldering tool when the split tip comes in contact with an electrically conductive material.

15. The power tool assembly of claim 10, wherein the cap is made from a hardened material sufficient to protect against impact damage.

16. A soldering tool assembly according to claim 15, wherein the cap is made of a plastic.

17. A soldering tool assembly according to claim 10, wherein the cap is removably affixed to the first receiving surface on the soldering tool by a friction fit, a clamp, or threaded surfaces when the soldering tool is not in use.

18. A soldering tool assembly according to claim 10, wherein the cap is removably affixed to the second receiving surface on the soldering tool by a friction fit, a clamp, or threaded surfaces when the soldering tool is in use.

19. A soldering tool assembly according to claim 10, wherein the second receiving surface is located on the posterior end of the soldering tool.
